(19) United States
(12) Patent Application Publication
(10) Pub. No.: US 2015/0144226 A1
(43) Pub. Date: May 28, 2015

(54) METHOD FOR MANUFACTURING WOODEN BILLET, WOODEN BASEBALL BAT AND BILLIARD/SNOOKER CUES

(71) Applicant: PRAKASHKUMAR NARMADASHANKAR SUTHAR, (US)

(72) Inventor: Prakashkumar Narmadashankar Suthar, Mumbai (IN)

(21) Appl. No.: 14/406,562

(22) PCT Filed: Jul. 17, 2013
(86) PCT No.: PCT/IN2013/000441

§ 371 Date: Dec. 23, 2014

(30) Foreign Application Priority Data
Jul. 24, 2012 (IN) 2114/MUM/2012

(51) Int. Cl. B27M 3/22; B27M 1/08; B27K 1/00; B27M 1/02

(52) U.S. Cl. CPC B27M 3/22; B27M 1/02; B27M 1/08; B27K 1/00
USPC 144/356

(57) ABSTRACT

A process for manufacturing wooden billets, baseball bats and billiard/snooker cues is disclosed. The process comprises softening the hardwoods and willow, which are typically North American Hardwoods and English and Kashmir willow having moisture content between 30-70%, by steaming, and then compressing the softened hardwoods and willow by longitudinal compression processes along the length to cause the axial fibres to cross-link. The process aims at providing wooden billets, baseball bats and snooker cues having uniform performance standardization, improvement in durability, strength, acceptability, anti-breakage and flexibility.

The following specification particularly describes the invention and the manner in which it is to be performed.

### FIELD OF DISCLOSURE

The present disclosure relates to a process for manufacturing wooden baseball bat billets, baseball bats and billiard/snooker cues.

### BACKGROUND

Most professional baseball leagues use wooden baseball bats during play. A major danger in the use of the wooden baseball bats is that they can break when they strike a pitched baseball, typically at the narrow handle part of the bat. This break is often clean and causes the bat to break in two pieces, where the momentum of the broken piece combined with the impact of the baseball causes the broken piece to go flying at a high speed towards other players or even the spectators. The broken end has jagged sharp edges and can cause serious injury if it strikes a person.

Therefore, only wooden baseball bats made from a single piece of wood of selective types and within a narrow range of specifications for dimensions and weight are permitted to be used in the major league games. Any type of modification to these bats, like using metal, plastic or reinforcements, is unwelcome because it may change the way in which the bat swings or the way the bat interacts with the ball or its effect thereof, thereby providing the batter with an advantage or a disadvantage with respect to other batters using conventional wooden bats. In the past several efforts have been made to strengthen the wooden baseball bats against breakage. Many of these modifications include applying a surface coating to the bat or gluing the radial pieces of wood together, which affects the striking surface of the bat, thereby altering how the bat interacts with a pitched baseball, and thus affecting the game of baseball.

### OBJECTS

An object of the present disclosure is to provide a method for manufacturing wooden billets for turning the baseball bat and wooden baseball bats, that conform to the specifications, dimensions, and hitting properties of wooden baseball bats used in the major leagues.

Another object of the present disclosure is to provide a method for manufacturing wooden billets for baseball bat and baseball bat turned out of the billet which does not break into a handle portion and a projectile portion, which may injure players or spectators.

Yet another object of the present disclosure is to provide a method for manufacturing wooden billets and wooden baseball bats, which are standardized and durable with high-strength, flexibility and improved performance.

One more object of the present disclosure is to provide a method for manufacturing billiard/snooker cues.

Other objects and advantages in the present disclosure will be more apparent from the following description when read in conjunction with the accompanying figures, which are not intended to limit the scope of the present disclosure.

### SUMMARY

In accordance with the present disclosure, there is provided a process for manufacturing wooden baseball bat billets, wooden baseball bats and billiard/snooker cues, said process comprising the following steps:
scanning a wood to determine characteristics of the wood by means of at least one parameter selected from moisture content, bending strength, elastic modulus, compression modulus, hardness and softness;
steaming said scanned wood by heating for obtaining a heated softened wood;
compressing said heated softened wood by means of longitudinal compression processes adapted as per the willow characteristics by compressing along the length of said softened wood to cause the axial fibers of said softened wood to cross-link and thereby strengthening the wood to obtain a processed wood; and
shaping the processed wood to obtain wooden baseball bat billet, baseball bat or snooker cue.

Typically, in accordance with the present disclosure, the process comprises cooling the processed wood prior to shaping.

Preferably, in accordance with the present disclosure, the process comprises drying the processed wood prior to shaping by a process selected from traditional drying and vacuum drying, to adjust the final uniform weight of the wooden billet, baseball bat and billiard/snooker cues.

Typically, in accordance with the present disclosure, wherein the wood is selected from English willow, Kashmir willow, North American Hardwoods, Hard Maple, American Northern White Ash and the like. Preferably, the hardwoods and willow are green wood. More preferably, the willow has moisture content between 30-70%.

### BRIEF DESCRIPTION OF THE ACCOMPANYING DRAWINGS

The disclosure will now be described with the help of the non-limiting accompanying drawings, in which,

FIG. 1 illustrates a schematic of hardwoods and willow/wooden billet;

FIG. 2 illustrates the heating/steaming step in accordance with the process of the present disclosure;

FIG. 3 &4 illustrates the compression step in accordance with the process of the present disclosure; and

FIG. 5 illustrates the shaping step in accordance with the process of the present disclosure.

### DETAILED DESCRIPTION OF THE ACCOMPANYING DRAWINGS

The disclosure will now be described with reference to the accompanying drawings which do not limit the scope and ambit of the disclosure. The description provided is purely by way of example and illustration.

The present disclosure envisages a process for producing wooden baseball bat billets, baseball bats and billiard/snooker cues having improved flexibility, durability, power and strength. The process of the present disclosure involves natural, artistic and mechanically controlled processes over the North American Hardwoods and willow for producing the wooden billets, baseball bats and the billiard/snooker cues. The billets are round sticks having a thickness of about 2.5 inches to 3.5 inches and length about 36 inches to 39 inches, from which the baseball bat is turned. The billet can also be one of the products sold to bat manufacturers in volume. The process of the present disclosure further avoids any risk of blue stain in the hardwoods and willow used for bats/cues while cold storage, steaming or heating for fumigation purposes. The present disclosure aims at providing processes over the willow/hardwood/cane used for making wooden billets, baseball bats and billiard cues for the purpose of producing uniform performance standardization, improvement, durability, strength, acceptability, anti-breakage and flexibility, so as to enhance the overall satisfaction of the bat/cue by the players on a national as well as international level.

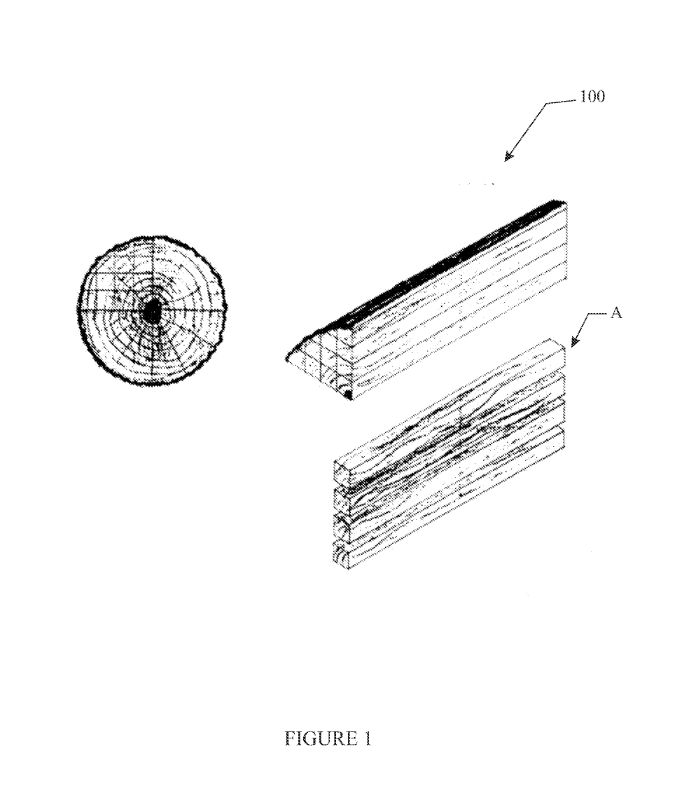

The Northern American hardwoods and willow 100 are illustrated in FIG. 1 of the accompanying drawings. The hardwoods and willow 100 can be Northern American Hardwoods, Hard Maple, Northern White Ash and other northern American species useful for manufacturing wooden billets for baseball bats and baseball bats (hereinafter referred to as “hardwoods”, “Billets” and “Bats”) and English willow, Kashmir willow or any other wood (hereinafter referred as “willow”). Each of the hardwoods and willow 100 are unique in terms of its nature, grain characteristics, hardness, softness, microstructure content and fibres. Therefore, it is necessary to standardize the hardwoods and willow 100 to obtain uniformity and maintain the appropriate standard in the billets, baseball bat or the billiard/snooker cue. The process of the present disclosure comprises scanning the hardwoods and willow 100 to obtain a scientific analysis to determine the hardwoods and willow characteristics, including hardwoods and willow moisture content, hardwoods and willow bending strength, hardwoods and willow elastic modulus, hardwoods and willow compression modulus, hardwoods and willow hardness and hardwoods and willow softness. Typically, the hardwoods and willow used in the process of the present disclosure is green hardwoods and willow having moisture content greater than 30%, preferably between 30-70%. These parameters help in ascertaining the amount of compressing, rolling and pressing that is required to obtain hardwoods and willow having standardized strength, durability, flexibility, and the like.

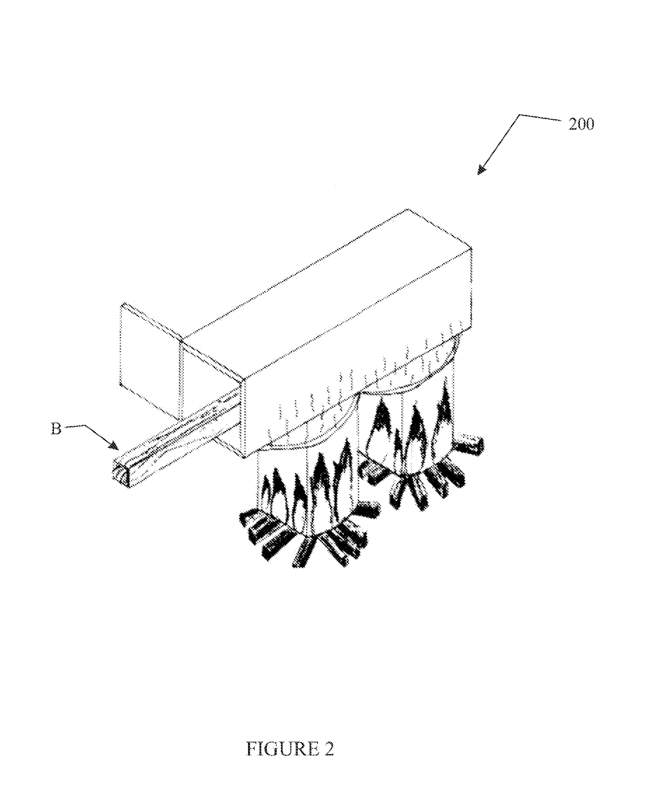

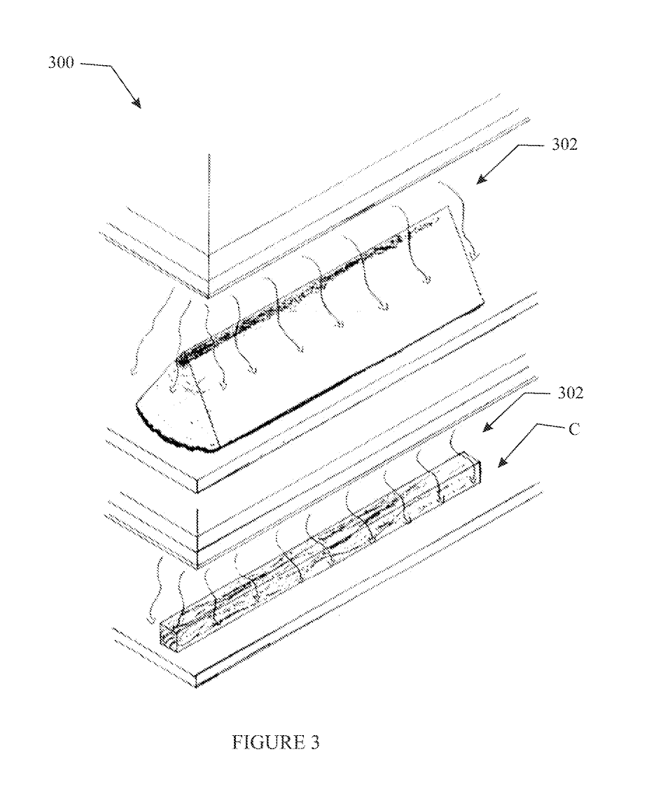

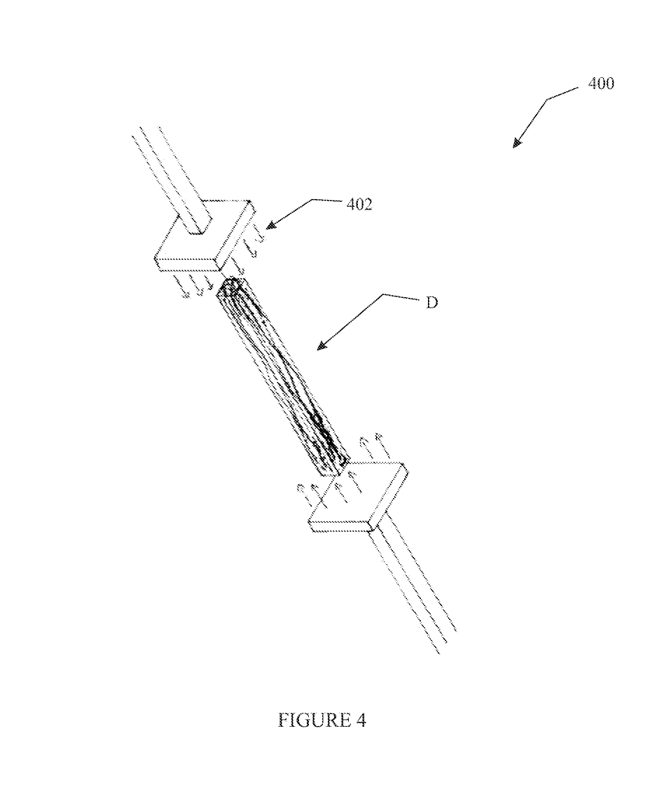

The scanned hardwoods and willow (A) are heated at or more than 100° C. and then passed through longitudinal compression processes, which are adapted according to the hardwoods and willow characteristics. The scanned hardwoods and willow (A) are softened by heating/steaming. The steaming step 200 is illustrated in FIG. 2. The steaming step 200 provides heated softened hardwoods and willow (B). The heated softened hardwoods and willow (B) are then strengthened in compressing steps 300 & 400, as illustrated in FIGS. 3 & 4, respectively. FIG. 3 of the accompanying drawings illustrates the longitudinal compression process 300. The longitudinal compression process 300 is a mechanical process which gives uniformity and standardization to the hardwoods and willow, thereby providing the standardized hardwoods and willow (C). The mechanical compression process uses a “Compwood System” designed by Bendwood Engineering which smoothens the hardwoods and willow in order to twist and bend the hardwoods and willow in several planes and in tight radii of curve. In the process 300, compression is applied on the hardwoods and willow, as depicted by arrows 302. During the compression process 300, the wood fibres become extremely pliable and strong and each of the hardwoods and willow becomes uniform in structure, strength and flexibility. Further, compression gives the hardwoods and willow a new structure and flexible features. The compressed wood allows for extreme changes in shape and can be bent in any direction. This adds new opportunities to work with different designs and aesthetics.

In the strengthening step 400, the standardized hardwoods and willow (C) are compressed along the length, width and thickness, particularly along the length of the standardized hardwoods and willow (C), as shown by arrows 402. The strengthening step 400 comprises fixing the hardwoods and willow along the sides by means of a hydraulic cylinder that presses the hardwoods and willow along the length. This process gives an even compression throughout the entire length. The compression process is automatically controlled by a PLC control unit. The strengthening step 400 causes the axial fibres in the hardwoods and willow to cross-link, thereby strengthening the hardwoods and willow to produce processed hardwoods and willow (D), which can be shaped.

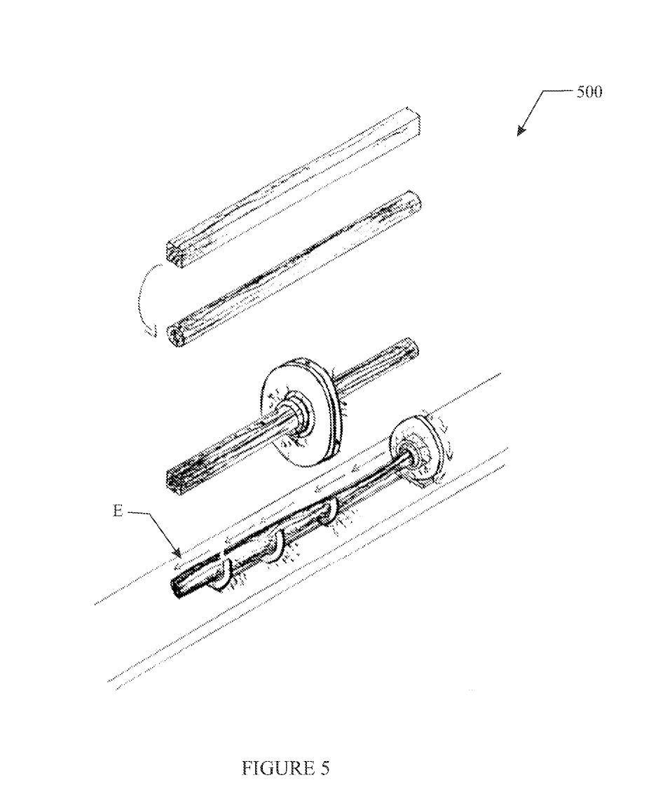

The processed hardwoods and willow (D) may be cooled or dried or can be directly machined for shaping into billets for the baseball bats or baseball bats or billiard/snooker cues. The drying can be done by a process selected from traditional drying or vacuum drying, to adjust the final uniform weight of the wooden billet, baseball bat and billiard/snooker cue. FIG. 5 illustrates the lengthwise shaping step 500 to obtain the artistically shaped billets, baseball bat or cue (E). The compressed hardwoods and willow obtains the same strength after drying as traditionally steam bent wood. The process produces wooden billets for baseball bat, baseball bats and billiard/snooker cues that conform to the specifications, dimensions, and hitting properties of bats/cues used in the major leagues/tournaments.

### TECHNICAL ADVANTAGES

A process for manufacturing wooden billets, baseball bats and billiard/snooker cues, as described in the present disclosure has several technical advantages including but not limited to the realization of:
the billets and baseball bats conform to the specifications, dimensions, and hitting properties of wooden baseball bats used in the major leagues;
the billets produce baseball bats which do not break into a handle portion and a projectile portion, which may injure players or spectators;
the wooden billets and baseball bats are standardized and durable with high-strength, flexibility and improved performance; and
the method can also be used to produce billiard/snooker cues having high strength, durability and improved performance.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

In view of the wide variety of embodiments to which the principles of the present disclosure can be applied, it should be understood that the illustrated embodiments are exemplary only. While considerable emphasis has been placed herein on the particular features of this disclosure, it will be appreciated that various modifications can be made, and that many changes can be made in the preferred embodiments without departing from the principle of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

I claim:

1. A process for manufacturing wooden baseball bat billets, wooden baseball bats and billiard/snooker cues, said process comprising the following steps:
scanning a wood to determine characteristics of the wood by means of at least one parameter selected from moisture content, bending strength, elastic modulus, compression modulus, hardness and softness;
steaming said scanned wood by heating for obtaining a heated softened wood;
compressing said heated softened wood by means of longitudinal compression processes adapted as per the wood characteristics by compressing along the length of said softened wood to cause the axial fibers of said softened wood to cross-link and thereby strengthening the wood to produce a processed wood;
shaping the processed wood to obtain wooden baseball bat billet, baseball bat or snooker cue.

2. The process as claimed in claim 1, which comprises cooling the processed wood prior to shaping.

3. The process as claimed in claim 1, which comprises drying the processed wood prior to shaping by a process selected from traditional drying and vacuum drying, to adjust the final uniform weight of the wooden billet, baseball bat and billiard/snooker cues.

4. The process as claimed in claim 1, wherein the wood is selected from English willow, Kashmir willow, North American Hardwoods, Hard Maple, American Northern White Ash and the like.

5. The process as claimed in claim 4, wherein the hardwoods and willow are green wood.

6. The process as claimed in claim 4, wherein the willow has moisture content between 30-70%.
